(19) United States
(12) Patent Application Publication
(10) Pub. No.: US 2022/0188135 A1
(43) Pub. Date: Jun. 16, 2022

(54) HARDWARE-BASED PROTECTION OF VIRTUAL FUNCTION RESOURCES

(71) Applicant: ATI TECHNOLOGIES ULC, Markham (CA)

(72) Inventors: Yinan JIANG, Markham (CA); Min ZHANG, Markham (CA)

(21) Appl. No.: 17/117,530

(22) Filed: Dec. 10, 2020

(51) Int. Cl. G06F 9/455; G06F 9/30; G06F 9/448; G06F 9/54

(52) U.S. Cl. CPC G06F 9/45558; G06F 9/30101; G06F 2009/45591; G06F 9/544; G06F 2009/45583; G06F 9/4498

(57) ABSTRACT

Virtual functions are implemented using a plurality of resources and physical function circuitry that executes a virtual function using information stored in the plurality of resources. A processing unit executes a host driver that selectively enables access to the plurality of resources by the virtual function based on an operational state of the processing unit. In some cases, a state machine that determines a state of the virtual function and the host driver that enables access to the plurality of resources by the virtual function based on the state of the virtual function executing on the processing unit. The subsets of the plurality of resources are used to implement a frame buffer, one or more context registers, a doorbell, and one or more mailbox registers.

### BACKGROUND

Processing units such as graphics processing units (GPUs) support virtualization that allows multiple virtual machines to use the hardware resources of the processing unit. Each virtual machine executes as a separate process that uses the hardware resources of the processing unit. Some virtual machines implement an operating system that allows the virtual machine to emulate an actual machine. Other virtual machines are designed to execute code in a platform-independent environment. A hypervisor creates and runs the virtual machines, which are also referred to as guest machines or guests. The virtual environment implemented on the processing unit provides virtual functions to other virtual components implemented on a physical machine. A single physical function implemented in the processing unit is used to support one or more virtual functions. The physical function allocates the virtual functions to different virtual machines on the physical machine on a time-sliced basis. For example, the physical function allocates a first virtual function to a first virtual machine in a first time interval and a second virtual function to a second virtual machine in a second, subsequent time interval. In some cases, a physical function in the processing unit supports as many as thirty-one virtual functions, although more or fewer virtual functions are supported in other cases. The single root input/output virtualization (SR IOV) specification allows multiple virtual machines (VMs) to share a processor interface to a single bus, such as a peripheral component interconnect express (PCIe) bus. Components access the virtual functions by transmitting requests over the bus.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that includes a graphics processing unit (GPU) that implements sharing of physical functions in a virtualized environment according to some embodiments.

FIG. 2 is a block diagram of a processing system that provide selective access to resources by virtual functions (VFs) according to some embodiments.

FIG. 3 is a block diagram of a state machine that is used to determine the state of a VF and selectively enable resource access by the VF according to some embodiments.

### DETAILED DESCRIPTION

The hardware resources of the GPU are partitioned according to SR-IOV using a physical function (PF) and one or more virtual functions (VFs). Each virtual function is associated with a single physical function so that the virtual function is implemented using the physical resources and circuitry of the associated physical function. In a native (host OS) environment, a physical function is used by native user mode and kernel mode drivers and all virtual functions are disabled. All the GPU resources are mapped to the physical function via trusted access. In a virtual environment, the physical function is used by a hypervisor (host VM) and the GPU exposes a certain number of virtual functions as per the PCIe SR-IOV standard, such as one virtual function per guest VM. Each virtual function is assigned to the guest VM by the hypervisor. Subsets of the GPU resources are mapped to the virtual functions and the subsets are partitioned to include a frame buffer, context registers, a doorbell aperture, and one or more mailbox registers used for VF-PF synchronization. During initialization of a VF, access to the frame buffer, context registers, and doorbell allocated to the VF is enabled by the host driver. However, in some cases, the host driver concurrently writes information to the frame buffer, the context registers, or the doorbell on behalf of the VF that owns these resources. Thus, the content of the resources can become corrupted or race conditions can be created by successive uncoordinated writes to the resources by the VF and the host driver. Corruption or race conditions can also be created during a reset of the VF.

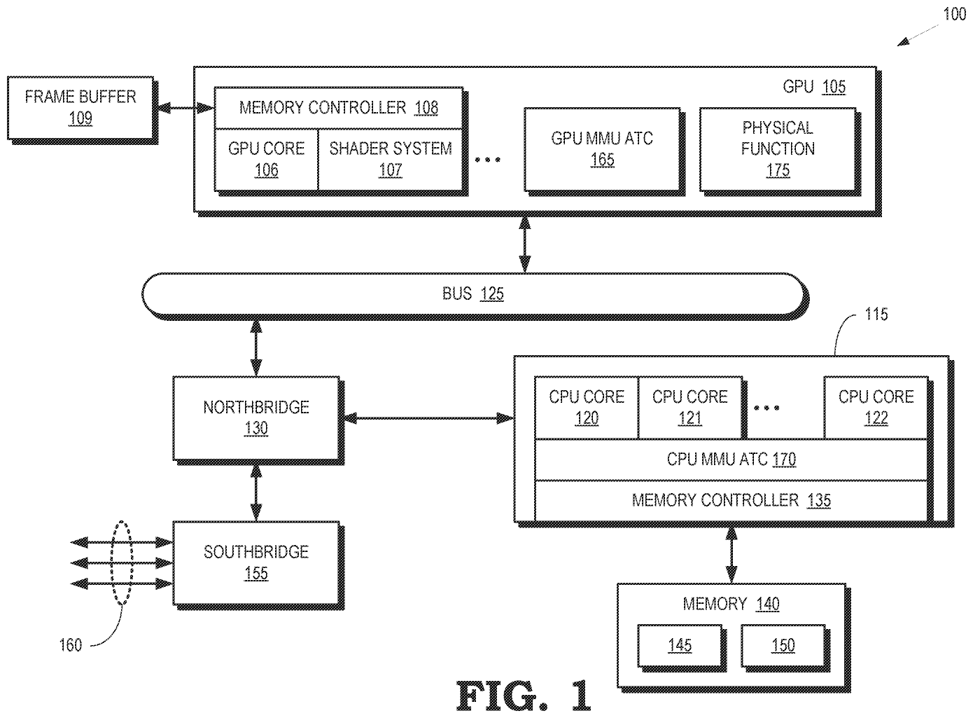

FIGS. 1-3 disclose techniques for reducing or avoiding corruption and race conditions in a processing unit resulting from concurrent access by a host driver and a virtual function (VF) to resources allocated to the VF by selectively enabling access to subsets of the resources by the VF depending on an operational state of the processing unit. In some embodiments, the subsets of the resources include a frame buffer, one or more context registers, a doorbell, and one or more mailbox registers. The host driver enables VF access to different subsets of the resources when the processing unit is in different states. The states include a first (default) state that disables VF access to the frame buffer, the context registers, and the doorbell, while allowing VF access to the mailbox registers. In a second state, the host driver enables VF access to the frame buffer, the context registers, the doorbell, and the mailbox registers. The second state is used for initialization, re-initialization, and reset of the VF. In a third state, the host driver selectively enables VF access to subsets of the resources based on risk, security, or threat levels associated with the subsets. In some embodiments, VF access to the frame buffer and the doorbell are enabled in the third set, but VF access to the context registers is disabled due to the relatively high risk associated with allowing access to the context registers. In some embodiments, the processing unit transitions to the first state in response to failure of a driver or detection of an invalid or malicious driver. The host driver enables access to the mailbox registers, frame buffer, and doorbell and disables access to the other registers by the VF until the VF transitions to the first (default) state, e.g., in response to a reset of the driver or installation/initialization of a new driver.

For ease of illustration, the system and techniques of the present disclosure are described in the example context of a GPU as the processing unit. However, these systems and techniques are not limited to this example, and thus reference to GPU applies equally to any of a variety of parallel processors (e.g., vector processors, graphics processing units (GPUs), general-purpose GPUs (GPGPUs), non-scalar processors, highly-parallel processors, artificial intelligence (AI) processors, inference engines, machine learning processors, other multithreaded processing units, and the like).

FIG. 1 is a block diagram of a processing system 100 that includes a graphics processing unit (GPU) 105 that implements sharing of physical functions in a virtualized environment according to some embodiments. The GPU 105 includes one or more GPU cores 106 that independently execute instructions concurrently or in parallel and one or more shader systems 107 that support 3D graphics or video rendering. For example, the shader system 107 can be used to improve visual presentation by increasing graphics rendering frame-per-second scores or patching areas of rendered images where a graphics engine did not accurately render the scene. A memory controller 108 provides an interface to a frame buffer 109 that stores frames during the rendering process. Some embodiments of the frame buffer 109 are implemented as a dynamic random access memory (DRAM). However, the frame buffer 109 can also be implemented using other types of memory including static random access memory (SRAM), nonvolatile RAM, and the like. Some embodiments of the GPU 105 include other circuitry such as an encoder format converter, a multiformat video codec, display output circuitry that provides an interface to a display or screen, and audio coprocessor, an audio codec for encoding/decoding audio signals, and the like.

The processing system 100 also includes a central processing unit (CPU) 115 for executing instructions. Some embodiments of the CPU 115 include multiple processor cores 120, 121, 122 (collectively referred to herein as “the CPU cores 120-122”) that can independently execute instructions concurrently or in parallel. In some embodiments, the GPU 105 operates as a discrete GPU (dGPU) that is connected to the CPU 115 via a bus 125 (such as a PCI-e bus) and a northbridge 130. The CPU 115 also includes a memory controller 135 that provides an interface between the CPU 115 and a memory 140. Some embodiments of the memory 140 are implemented as a DRAM, an SRAM, nonvolatile RAM, and the like. The CPU 115 executes instructions such as program code 145 stored in the memory 140 and the CPU 115 stores information 150 in the memory 140 such as the results of the executed instructions. The CPU 115 is also able to initiate graphics processing by issuing draw calls to the GPU 105. A draw call is a command that is generated by the CPU 115 and transmitted to the GPU 105 to instruct the GPU 105 render an object in a frame (or a portion of an object).

A southbridge 155 is connected to the northbridge 130. The southbridge 155 provides one or more interfaces 160 to peripheral units associated with the processing system 100. Some embodiments of the interfaces 160 include interfaces to peripheral units such as universal serial bus (USB) devices, General Purpose I/O (GPIO), SATA for hard disk drive, serial peripheral bus interfaces like SPI, I2C, and the like.

The GPU 105 includes a GPU virtual memory management unit with address translation controller (GPU MMU ATC) 165 and the CPU 115 includes a CPU MMU ATC 170. The GPU MMU ATC 165 and the CPU MMU ATC 170 provide translation of virtual memory address (VA) to physical memory address (PA) by using a multilevel translation logic and a set of translation tables maintained by operating system kernel mode driver (KMD). Thus, application processes that execute on main OS or in the guest OS each have their own virtual address space for CPU operations and GPU rendering. The GPU MMU ATC 165 and the CPU MMU ATC 170 therefore support virtualization of GPU and CPU cores. The GPU 105 has its own memory management unit (MMU) which translates per-process GPU virtual addresses to physical addresses. Each process has separate CPU and GPU virtual address spaces that use distinct page tables. The video memory manager manages the GPU virtual address space of all processes and oversees allocating, growing, updating, ensuring residency of memory pages and freeing page tables.

The GPU 105 also includes one or more physical functions (PFs) 175. In some embodiments, the physical function 175 is a hardware acceleration function such as multimedia decoding, multimedia encoding, video decoding, video encoding, audio decoding, and audio encoding. The virtual environment implemented in the memory 140 supports a physical function and a set of virtual functions (VFs) exposed to the guest VMs. The GPU 105 further includes a set of resources (not shown in FIG. 1 in the interest of clarity) that store information associated with processing performed by kernel mode units. Subsets of the set of resources are allocated to store information associated with the virtual functions. In some embodiments, the subsets of the GPU resources are mapped to the virtual functions and the subsets are partitioned to include a frame buffer, context registers, a doorbell aperture, and one or more mailbox registers used for VF-PF synchronization. The physical function 175 executes on behalf of one of the virtual functions for one of the guest VMs based on the information stored in a corresponding one of the subsets, as discussed in detail herein.

Some embodiments of the GPU 105 execute a host driver that selectively enables access to the resources by the VFs based on an operational state of the GPU 105. For example, the host driver enables access to the mailbox registers for all states of the VF executing on the GPU 105. However, the host driver disables access to the frame buffer, context registers, and doorbell during a first (default) state of the VF. The host driver enables access to the frame buffer, the context registers, and the doorbell during a second state of the VF to allow the VF to perform operations related to initializing, re-initializing, or resetting the VF. The VF is executing normally in the third state and so the host driver selectively enables access to the subsets of the resources based on a risk level, a security level, or a threat level associated with the subsets. Some embodiments of the host driver enable access to the frame buffer and the doorbell, but disable access to the context registers due to the relatively high risk/threat of exposing the context registers to the VF at runtime, e.g., relative to the lower risks/threats associated with the frame buffer, the doorbell, and the mailbox registers. In some embodiments, the GPU 105 implements a state machine (not shown in FIG. 1 the interest of clarity) that manages or modifies the states of the VF in the GPU 105.

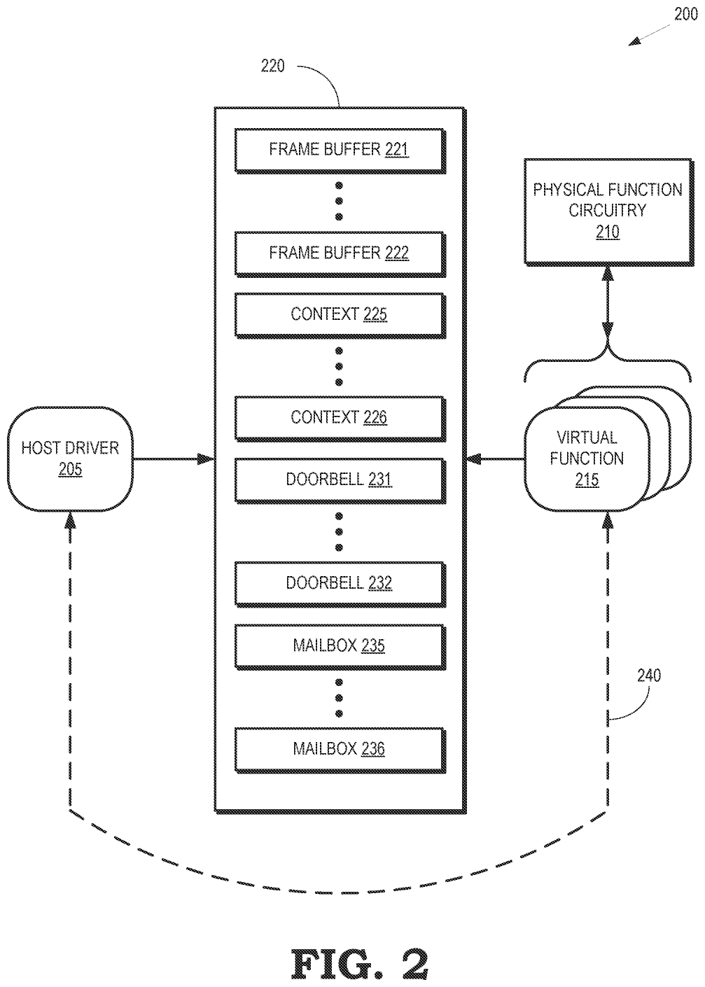

FIG. 2 is a block diagram of a processing system 200 that provide selective access to resources by VFs according to some embodiments. The processing system 200 is used to implement some embodiments of the processing system 100 shown in FIG. 1. In the illustrated embodiment, the processing system 200 implements a host driver 205, physical function circuitry 210, and one or more virtual functions (VFs) 215 that execute on the physical function circuitry 210, as discussed herein.

The processing system 200 implements a set 220 of resources that are allocated to the VFs 215 executing on the physical function circuitry 210. In the illustrated embodiment, the set 220 is partitioned into subsets of resources that are allocated to different VFs 215. For example, the subset of the resources that is reserved for frame buffers is partitioned into a frame buffer subset 221 that is allocated to the VF 215 and one or more other frame buffer subsets 222 that are allocated to other virtual functions. The subset of the resources that is reserved for context registers is partitioned into a context subset 225 that is allocated to the VF 215 and one or more other context subsets 226 that are allocated to other virtual functions. The subset of the resources that is reserved for doorbells is partitioned into a doorbell 231 that is allocated to the VF 215 and one or more other doorbells 232 that are allocated to other virtual functions. The subset of the resources that is reserved for mailbox registers is partitioned into the mailbox subset 235 that is allocated to the VF 215 and one or more other mailbox subsets 236 that are allocated to other virtual functions.

During initialization of the VF 215 (or other virtual functions), the host driver 205 provides signaling 240 to the VF 215 (or other virtual functions) that selectively enables the VF 215 with access to the frame buffer 221, context registers 225, doorbell 231, and mailbox registers 235 that are allocated to the VF 215. However, in some cases, the host driver 205 concurrently writes information to one or more of the frame buffer 221, the context registers 225, or the doorbell 231 on behalf of the VF 215 that owns these registers. Thus, the content of the resources can become corrupted or race conditions can be created by successive uncoordinated writes to the resources by the VF 215 and the host driver 205. Corruption or race conditions can also be created during a reset of the VF 215 and corresponding resources 221, 225, 231. The host driver 205 therefore uses the signaling 240 to selectively enable subsets of the set 220 of resources based on an operational state of the corresponding VF 215.

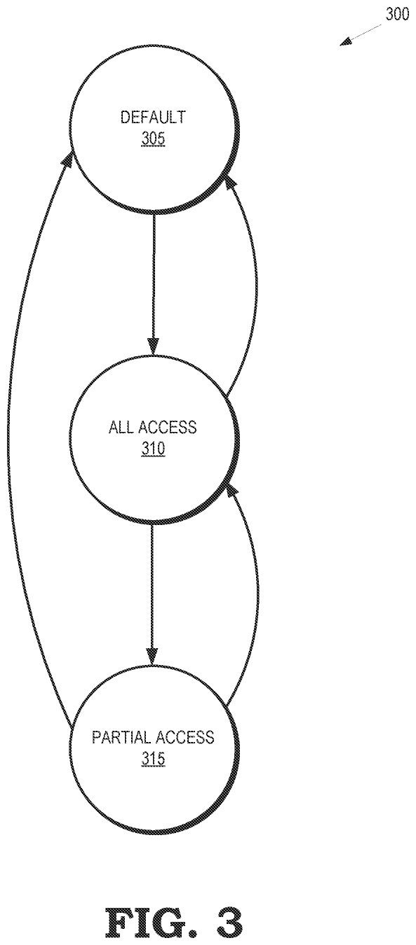

FIG. 3 is a block diagram of a state machine 300 that is used to determine the state of a VF and selectively enable resources access by the VF according to some embodiments. The state machine 300 is implemented in some embodiments of the processing system 100 shown in FIG. 1 and the processing system 200 shown in FIG. 2. In the illustrated embodiment, the state machine 300 provides a set of states and defines transitions between the states for the VF. The set of states includes a default state 305 that is applied to the VF when the conditions for the other states are not satisfied by the VF. The set of states also includes an “all access” state 310 that is used to initialize, re-initialize, or reset of the VF and a “partial access” state 315 that is used during runtime for the VF.

In operation, the state machine 300 places the VF in the default state 305 if there is no other appropriate state for the VF. For example, the state machine 300 places the VF in the default state 305 in response to a world switch when the processing unit stops or suspends execution of the VF and changes to executing another VF. In the default state 305, the host driver disables access to the frame buffer, the context registers, and the doorbell. The host driver also enables access to the mailbox registers in the default state 305 to support communication between the VF and the PF that implements the VF.

The state machine 300 modifies the state of the VF to the “all access” state 310 during initialization, re-initialization, or reset of the VF. For example, the state machine 300 places the VF in the “all access” state 310 in response to the processing unit initializing the VF. The host driver enables access to the frame buffer, the context registers, the doorbell, and the mailbox registers when the VF is in the “all access” state 310. The VF can therefore perform configuration operations related to initiating or resetting the VF by writing information to the frame buffer, the context registers, the doorbell, or the mailbox registers, as necessary. Limiting the “all access” state 310 to time intervals used for initialization, re-initialization, or reset of the VF also reduces the risk of exposing the contents of the registers.

However, if the state machine 300 detects a failure of a driver associated with the VF or an invalid, unsupported, or malicious driver, e.g., in response to initializing the VF and the corresponding driver, the state machine 300 transitions the VF from the “all access” state 310 to the default state 305. The host driver disables access to the frame buffer, the context registers, and the doorbell in the default state 305 to prevent corruption or malicious modification of the contents of these resources. The state machine 300 remains in the default state 305 until the current driver is re-initialized with a valid driver or a new driver is loaded, in which case the state machine 300 transitions back to the “all access” state 310 to continue initializing, re-initializing, or resetting the VF.

The state machine 300 transitions from the “all access” state 310 to the “partial access” state 315 in response to completing initialization, re-initialization, or resetting of the VF. The “partial access” state 315 is used during runtime of the VF and access to subsets of the resources is determined based on a risk level, a security level, or a threat level associated with the subsets. Some embodiments of the state machine 300 enable access to the frame buffer and the doorbell are enabled in the “partial access” state 315, but disable access to the context registers due to the relatively high risk associated with allowing access to the context registers. However, other combinations of registers are enabled or disabled in other embodiments. The state machine 300 transits the state of the VF back to the all access state 310 in response to a driver unload event and transits to the default state 305 in response to end of the usage VF notification or in response to the detection of end of VF usage.

However, if the state machine 300 receives a notification of end of VF usage, the state machine 300 transitions the VF from the “all access” state 310 to the default state 305. The host driver disables access to the frame buffer, the context registers, and the doorbell in the default state 305 to prevent corruption or malicious modification of the contents of these resources. The state machine 300 remains in the default state 305 until a new driver is loaded, in which case the state machine 300 transitions back to the “all access” state 310 to continue initializing, re-initializing, or resetting the VF.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. An apparatus comprising:
a plurality of resources configured to store information;
physical function circuitry configured to execute a virtual function using information stored in the plurality of resources; and
a processing unit configured to execute a host driver that selectively enables access to the plurality of resources by the virtual function based on an operational state of the processing unit.

2. The apparatus of claim 1, wherein the processing unit is configured to selectively enable access to different combinations of subsets of the plurality of resources by the virtual function concurrently with the processing unit being in different operational states.

3. The apparatus of claim 2, wherein the subsets of the plurality of resources comprise a first subset to implement a frame buffer, a second subset to implement at least one context register, a third subset to implement a doorbell, and a fourth subset to implement at least one mailbox register.

4. The apparatus of claim 3, wherein the operational state of the processing unit comprises one of: a first state that is a default state of the virtual function, a second state of the virtual function that is used for initialization, re-initialization, and reset of the virtual function, and a third state of the virtual function in which the virtual function is executing on the physical function circuitry.

5. The apparatus of claim 4, wherein the host driver is configured to disable access to the first subset, the second subset, and the third subset by the virtual function and enables access to the fourth subset by the virtual function in response to the virtual function being in the first state.

6. The apparatus of claim 4, wherein the host driver is configured to enable access to the first subset, the second subset, the third subset, and the fourth subset by the virtual function in response to the virtual function being in the second state.

7. The apparatus of claim 4, wherein the host driver is configured to enable access to the subsets of the resources by the virtual function based on at least one of a risk level, a security level, and a threat level associated with the subsets in response to the virtual function being in the third state.

8. The apparatus of claim 7, wherein the host driver is configured to enable access to the first subset, the third subset, and the fourth subset by the virtual function and disables access to the second subset by the virtual function in response to the virtual function being in the third state.

9. A method comprising:
executing, on a physical function circuitry, a virtual function using information stored in a plurality of resources configured to store information; and
selectively enabling, at a host driver executing on a processing unit, access to the plurality of resources by the virtual function based on an operational state of the processing unit.

10. The method of claim 9, wherein selectively enabling access to the plurality of resources comprises selectively enabling access to different combinations of subsets of the plurality of resources by the virtual function concurrently with the processing unit being in different operational states.

11. The method of claim 10, wherein the subsets of the plurality of resources comprise a first subset to implement a frame buffer, a second subset to implement at least one context register, a third subset to implement a doorbell, and a fourth subset to implement at least one mailbox register.

12. The method of claim 11, wherein the operational state of the processing unit comprises one of: a first state that is a default state of the virtual function, a second state of the virtual function that is used for initialization, re-initialization, and reset of the virtual function, and a third state of the virtual function in which the virtual function is executing on the physical function circuitry.

13. The method of claim 12, wherein selectively enabling access to the plurality of resources comprises disabling access to the first subset, the second subset, and the third subset by the virtual function and enabling access to the fourth subset by the virtual function in response to the virtual function being in the first state.

14. The method of claim 12, wherein selectively enabling access to the plurality of resources comprises enabling access to the first subset, the second subset, the third subset, and the fourth subset by the virtual function in response to the virtual function being in the second state.

15. The method of claim 12, wherein selectively enabling access to the plurality of resources comprises enabling access to the subsets of the resources by the virtual function based on at least one of a risk level, a security level, and a threat level associated with the subsets in response to the virtual function being in the third state.

16. The method of claim 15, wherein selectively enabling access to the plurality of resources comprises enabling access to the first subset, the third subset, and the fourth subset by the virtual function and disabling access to the second subset by the virtual function in response to the virtual function being in the third state.

17. An apparatus comprising:
physical function circuitry configured to execute a virtual function using information stored in a plurality of resources;
a state machine configured to determine a state of the virtual function; and
a processing unit configured to execute a host driver that selectively enables access to the plurality of resources by the virtual function based on the state of the virtual function.

18. The apparatus of claim 17, wherein the host driver is configured to selectively modify access to subsets of the plurality of resources by the virtual function in response to the state machine changing the state of the virtual function.

19. The apparatus of claim 18, wherein the subsets of the plurality of resources comprise a first subset to implement a frame buffer, a second subset to implement at least one context register, a third subset to implement a doorbell, and a fourth subset to implement at least one mailbox register.

20. The apparatus of claim 17, wherein the state of the virtual function comprises one of: a first state that is a default state of the virtual function, a second state of the virtual function that is used for initialization, re-initialization, and reset of the virtual function, and a third state of the virtual function in which the virtual function is executing on the physical function circuitry.
